(19) United States
(12) Patent Application Publication
(10) Pub. No.: US 2008/0166085 A1
(43) Pub. Date: Jul. 10, 2008

(54) SEMICONDUCTOR LASER MODULE

(75) Inventors: Akihiro Ito, Kawasaki (JP); Yusuke Kurihara, Kawasaki (JP); Junichi Shimizu, Kawasaki (JP); Hideyuki Yamada, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/967,287

(22) Filed: Dec. 31, 2007

(30) Foreign Application Priority Data
Jan. 10, 2007 (JP) 2007-002591

(51) Int. Cl. G02B 6/26

(52) U.S. Cl. 385/11

(57) ABSTRACT

A receptacle type semiconductor laser module (TOSA) includes a semiconductor laser, a lens, and a fiber stub. The fiber stub has a slantwise cut surface to which a emission light emitted from the semiconductor laser and passing through the lens is incident. The cut surface is arranged in a position deviated from the focus of the lens in the direction of the optical axis of the fiber stub. The semiconductor laser module further includes a fixed optical attenuator arranged on a path of an emission light of the semiconductor laser and having an incident surface being oblique to an optical axis of the semiconductor laser. By such a configuration, a coupling fluctuation caused by an eccentricity of the optical fiber cord connected to the fiber stub and a near-end reflection can be suppressed.

### BACKGROUND OF THE INVENTION

1. Field of the Invention

The present invention relates to a semiconductor laser module and, more particularly, to a transmitter optical sub assembly (abbreviated as a “TOSA”) of a receptacle type for communications. This Patent Application is based on Japanese Patent Application No. 2007-002591. This disclosure of the Japanese Patent Application is incorporated herein by reference.

2. Description of Related Art

Most of optical communication devices achieve conversion between an electric signal and an optical signal, and the connection to an optical fiber serving as a transmission medium by the use of an optical transceiver module. In operating a communication device, an optical transceiver which is suitable with an environmental medium such as a communication rate, a communication distance and a transmission medium is selected and provided to a communication device.

On a transmission side of the optical transceiver includes a drive circuit for mainly converting a transmitting electric signal into a laser driving electric signal, a laser assembly for converting an electric signal into an optical signal, a connector for performing connection to an outside optical fiber cord, and the like.

In the industry regarding the optical communication, a semiconductor laser module equipped with a semiconductor laser and some of functions of an optical connector on a transmission side is referred to as a transmitter optical sub assembly (abbreviated as a “TOSA”). The optical fiber cord is detachably attached to an optical connector. The optical connector is constituted of a receptacle unit for mainly performing optical connection to the optical fiber cord, and a housing unit for mainly keeping a mechanical strength. The TOSA designates a semiconductor laser module equipped with the function of the receptacle unit among the functions of the optical connector.

The TOSA includes a semiconductor laser for performing an electro-optic conversion, a sub mount for holding the semiconductor laser thereon, a lens for focusing a laser beam emitted from the semiconductor laser on a fiber stub constituting the receptacle serving as a part of the optical connector, a photodetector for monitoring an optical output intensity of the semiconductor laser, a stem for packaging the above-described constituents, a hermetic sealing cap and the like. Normally, a beam incident surface of the fiber stub or the like is cut slantwise with respect to the optical axis of the fiber stub, and further, a laser beam enters at a predetermined angle so as to suppress any near-end reflection.

In some cases, a great quantity of current is applied to the semiconductor laser in order to secure high frequency characteristics, and therefore, the output attenuation of the TOSA need be adjusted in order to input a desired optical output into the optical fiber cord connected to the TOSA.

In Japanese Laid-Open Patent JP-P2004-138864A, an example of an optical output attenuation adjusting method for a semiconductor laser module is disclosed. One example disclosed in the document is a method for adjusting the coordinates of a fiber stub in an optically axial direction, defocusing a laser beam focused on a beam incident surface of the fiber stub, and reducing the coupling efficiency of the laser beam to be coupled to the fiber stub, thus adjusting optical output attenuation. Another example disclosed in the document is a method for focusing a laser beam on a beam incident surface of a fiber stub, rotating an isolator, and reducing the transmittance of the laser beam, thus adjusting optical output attenuation.

In Japanese Laid-Open Patent Application JP-A-Heisei, 09-218326, a technique for applying a neutral density (abbreviated as “an ND”) filter film to a lens so as to reduce a transmittance of a beam is disclosed. Besides, related techniques are also disclosed in Japanese Laid-Open Patent Application JP-P2006-163351A and JP-P2006-19078A.

### SUMMARY

An optical fiber cord is connected to a TOSA in its receptacle opening. A fiber stub and the optical fiber cord are optically coupled to each other in a mating manner. At this time, ideally, the center axis of the fiber stub and that of the optical fiber cord are to be the same. In actual, an optical fiber generally has a certain definite eccentricity due to fabrication variations, and therefore, the amount and orientation of the core is varied per individual optical fiber. Such an eccentricity causes the fluctuation of the coupling efficiency which occurs when the optical fiber cord is rotated in a state in which the optical fiber cord is fitted to the receptacle opening, namely, the fluctuation depending on the fitting condition of the optical fiber cord. This fluctuation is referred to as a rotational fluctuation. The rotational fluctuation need be small from the viewpoint of the configuration of a level diagram of an optical output.

The rotational fluctuation can be adjusted by defocusing the laser beam. However, this adjusting method raises the following problems: a spot size of the laser beam incident into the fiber stub becomes much larger than a core diameter of the fiber stub caused by the defocusing, thereby producing a beam leaking to cladding and the cladding mode propagation. It has been known that the cladding mode is propagated in the cladding while meandering in the cladding, and therefore, reaches an emission end inside of a short optical fiber such as the fiber stub without any attenuation. As a consequence, an optical intensity distribution at the fiber stub emission surface becomes asymmetric with respect to the optical axis of the fiber stub, thereby unfavorably increasing the coupling fluctuation in addition to the eccentricity of the fiber.

In the meantime, the rotational fluctuation can also be adjusted by rotating the isolator while the laser beam is focused. In this adjusting method, the cladding mode can be suppressed. However, the following problems are raised: an incident surface of the isolator also must be normally disposed with an inclination at a predetermined angle with respect to the optical axis of the laser beam in order to prevent any near-end reflection. However, it is difficult to adjust the rotation angle while keeping a predetermined inclination.

In one embodiment of the present invention, a semiconductor laser module includes: a semiconductor laser; a lens; a fiber stub having a slantwise cut surface to which a emission light emitted from the semiconductor laser and passing through the lens is incident, and the cut surface is arranged in a position deviated from a focus of the lens in a direction of an optical axis of the fiber stub; and a fixed optical attenuator arranged on a path of an emission light of the semiconductor laser and having an incident surface being oblique to an optical axis of the semiconductor laser.

According to the present invention, a semiconductor laser module (abbreviated as a “TOSA”) of a receptacle type, in which a coupling fluctuation caused by the eccentricity of an optical fiber cord to be connected to a fiber stub is small and a near-end reflection is suppressed, can be provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a cross-sectional side view showing a semiconductor laser module of a receptacle type in a first embodiment according to the present invention;

FIG. 2 shows cross-sectional side and top views of an arrangement of a semiconductor laser, a lens and a fiber ferrule in the semiconductor laser module in a first embodiment;

FIG. 3 is a graph illustrating the relationship between the transmittance of a polarizer and the relative angle between the polarization orientation of the polarizer and the transmitted light;

FIG. 4A shows cross-sectional and top views for explaining a laser beam propagation inside of a fiber stub;

FIG. 4B shows cross-sectional and top views for explaining a laser beam propagation inside of a fiber stub;

FIG. 5 is a view showing an optical fiber cord connected to the semiconductor laser module in a first embodiment;

FIG. 6 shows graphs illustrating measurement results of rotational fluctuations;

FIG. 7 is a graph illustrating the relationship between the maximum rotational fluctuation and the deviated distance;

FIG. 8A shows diagrams for explaining an optical intensity distribution at an output end of the fiber stub;

FIG. 8B shows diagrams for explaining an optical intensity distribution at an output end of the fiber stub;

FIG. 9 is a cross-sectional view showing a semiconductor laser module of a receptacle type in a second embodiment according to the present invention;

FIG. 10 is a cross-sectional view showing a semiconductor laser module of a receptacle type in a third embodiment according to the present invention;

FIG. 11 is a cross-sectional view showing a semiconductor laser module of a receptacle type in a fourth embodiment according to the present invention; and

FIG. 12 is a cross-sectional view showing a semiconductor laser module of a receptacle type in a fifth embodiment according to the present invention.

### DESCRIPTION OF THE PREFERRED EMBODIMENTS

Hereinafter, a semiconductor laser module according to embodiments of the present invention will be described with reference to the attached drawings.

### First Embodiment

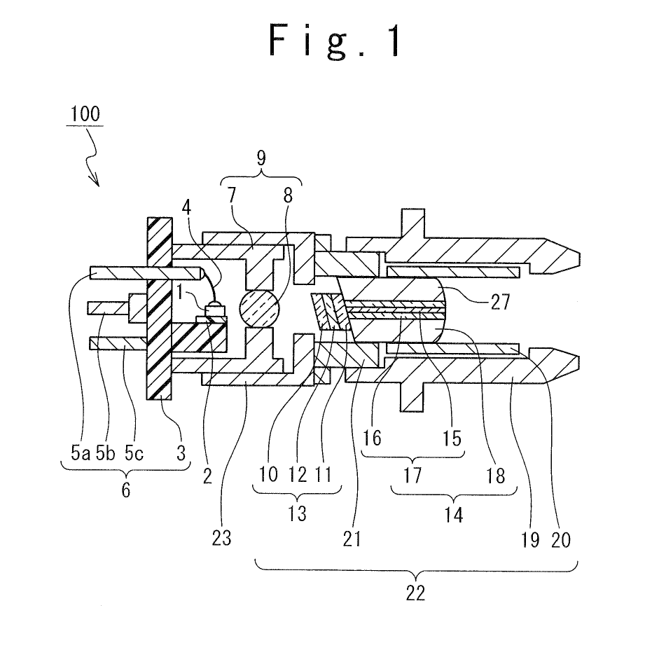

FIG. 1 is a cross-sectional side view showing a semiconductor laser module (TOSA) 100 of a receptacle type in a first embodiment according to the present invention. A semiconductor laser 1 is mounted on a sub mount 2, and in this state, it is packaged in a header 3. The semiconductor laser 1 is exemplified by a semiconductor laser of a distribution feedback type for 10 Gb/s. The semiconductor laser 1 is packaged by using AuSn solder, Ag paste or the like. The semiconductor laser 1 is electrically connected to a lead 5a via a gold wire 4. A stem 6 is a member constituted of leads 5a, 5b and 5c and the header 3. Although the number of leads is set to three in FIG. 1, the number may be appropriately increased or decreased, as necessary. A photodiode for monitoring an optical output is appropriately arranged behind the semiconductor laser 1, although not shown in FIG. 1.

In front of the output side of the semiconductor laser 1 is disposed a lens 8 fixed to a cap 7 forming an optical system. A ball lens, for example, is used as the lens 8. A lens cap 9 including the lens 8 and the cap 7 is secured to the stem 5 for the purpose of hermetic sealing and holding. In front of the lens cap 9 is disposed a fiber stub 14 having a slantwise cut surface, to which an isolator 13 constituted of a first polarizer 10, a second polarizer 11 and a Faraday rotator 12 is stuck. The fiber stub 14 includes an optical fiber 17 constituted of a core 15 and cladding 16, and a ferrule 18 for protecting the optical fiber 17. The optical fiber 17 is exemplified by a single mode fiber having a core diameter of 10 μm. The ferrule 18 is made of, for example, zirconium. A magnet for applying a magnetic field to the Faraday rotator 12 is disposed sideways of the isolator 13, although not shown in FIG. 1.

The fiber stub 14 is fixed inside of a metallic cylinder 19 via a sleeve 20, to be thus secured to the metallic cylinder 19 and another metallic cylinder 21. Such a section is referred to as a receptacle 22. A slide holder 23, the metallic cylinder 21 and the fixed lens cap 9 are secured to each other by using, for example, YAG welding.

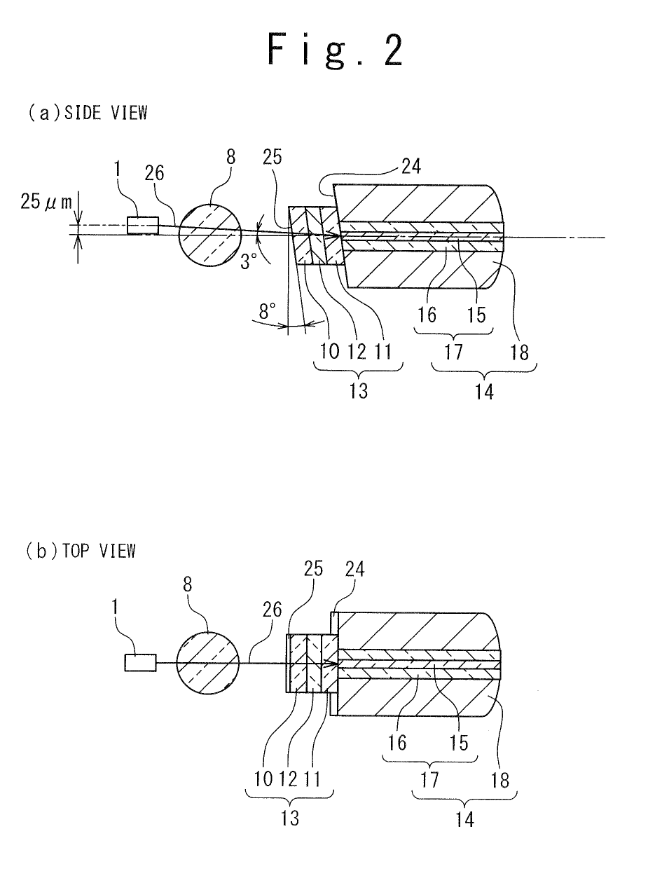

FIG. 2 shows the arrangement of the semiconductor laser 1, the lens 8 and the fiber ferrule 14 in the semiconductor laser module 100 in a first embodiment. FIG. 2(a) is a cross-sectional side view and FIG. 2(b) is a cross-sectional top view. As shown in FIG. 2(a), a beam incident surface 24 of the fiber stub 14 is cut on a slant with an inclination with respect to a surface vertical to the optical axis of the optical fiber 17. The inclination is about 8° in the present embodiment. The isolator 13 attached to the beam incident surface 24 has a beam incident surface 25 parallel to the beam incident surface 24. Moreover, the semiconductor laser 1 is disposed such that an optical axis of a beam 26 emitted from the semiconductor laser 1 enters with an inclination of about 3° with respect to a line parallel to the central axis of the optical fiber 17. A beam emitting surface of the semiconductor laser 1 is deviated by about 25 μm with respect to the optical axis of the optical fiber 17. In the meantime, when viewed from above as shown in FIG. 2(b), the semiconductor laser 1, the lens 8 and the fiber stub 14 are arranged such that the beam 26 emitted from the semiconductor laser 1 accords with the optical axis of the optical fiber 17. This positional relationship can sufficiently suppress a light beam returned to the semiconductor laser 1 caused by the near-end reflection of the isolator 13 at the beam incident surface 25, thus achieving a stable operation of the semiconductor laser 1.

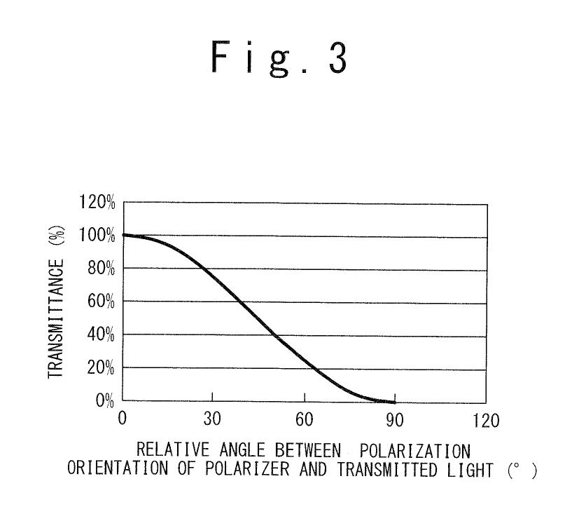

The first polarizer 10, into which the emitted beam 26 in the semiconductor laser 1 is incident, is disposed slantwise at an angle of 45° with respect to a plane of polarization of the emitted beam 26 in the semiconductor laser 1. FIG. 3 is a graph illustrating the relationship between the transmittance of the polarizer and the inclination of the plane of polarization of a transmitted beam with respect to the polarizer, namely, the relative angle between the polarization orientation of the polarizer and the transmitted light. The transmittance is 50% in the present embodiment, thus giving an attenuation of 3 dB. The plane of polarization of the emitted beam 26 from the semiconductor laser 1, which transmits the first polarizer 10, is rotated at an angle of 45° by the Faraday rotator 12. The second polarizer 11 is disposed with rotation at an angle of 45° with respect to the first polarizer 10, so that the isolator 13 serves as a fixed optical attenuator of 3 dB which is disposed on the optical path of the emitted beam 6 in the semiconductor laser 1. A conventional isolator can be used as the isolator 13 which is reversely disposed. Here, the rotational angle of the first polarizer 10 is not limited to an angle of 45°. The attenuation can be appropriately set based on the relationship illustrated in FIG. 3 by preparing a special isolator, as required.

Next, an optical output adjustment in the semiconductor laser module 100 in the present embodiment will be explained. In order to obtain a high relaxation oscillation frequency required for 10 Gb/s operation of the semiconductor laser 1, an average driving current of an oscillation threshold current of +25 mA is required. Under this condition, the intensity of the emitted beam of the semiconductor laser 1 reaches about 10 mW. In the meantime, an optical output of an optical transceiver needs to be, for example, 0.6 mW defined by IEEE 802.3ae. In this case, it is necessary to adjustably attenuate the emitted beam intensity by about 12 dB.

Since the entire length of the transceiver has been previously defined in accordance with a certain standard, the entire length of the TOSA is also limited. In order to clear the limit, a lens having φ of 0.8 mm and a refractive index as high as 1.77, for example, is used as the lens 8 in the present embodiment.

In the case where a focusing position by the lens is set at the beam incident surface 24 of the fiber stub 14 cut slantwise, the coupling efficiency of the lens system becomes 7 dB, so that 10 dB is obtained by adding it to the attenuation of 3 dB at the isolator 13. The residual 2 dB is adjusted by deviating the focusing position of the lens 8 from the beam incident surface 24 of the fiber stub 14 in the direction of the optical axis of the fiber stub 14 by a predetermined distance, which is about 150 μm in the present embodiment. In the state in which a single mode optical fiber cord 55 having an optical fiber 53 including a core 51 and cladding 52 and a ferrule 54 is disposed in the receptacle 22, the semiconductor laser 1 is operated, the slide holder 23 is adjusted lengthwise to be fixed such that the optical output becomes 0.6 mW while monitoring the optical output via the single mode optical fiber cord 55. The distance is adjusted by about 100 μm in the present embodiment.

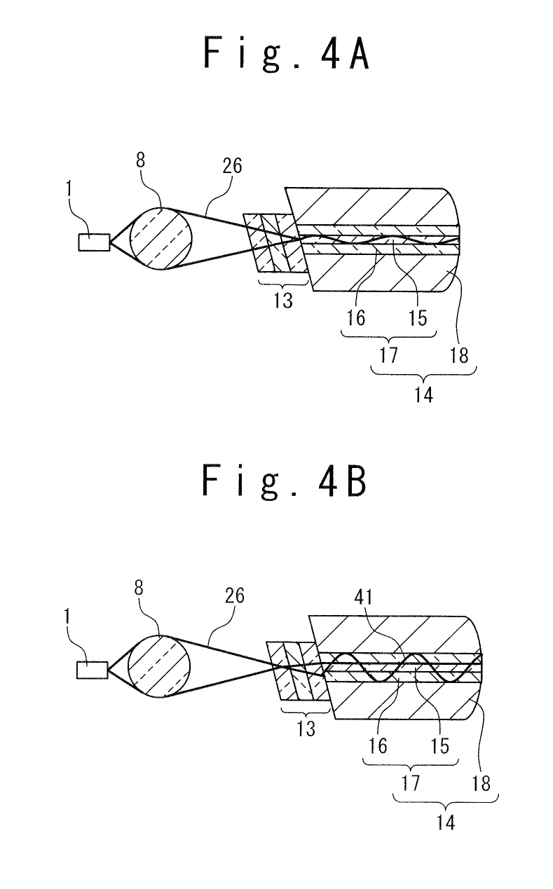

Next, the effect according to the present embodiment will be explained. FIGS. 4A and 4B show views for explaining a laser beam propagated inside of the fiber stub. FIG. 4A shows the focusing position of the lens which almost accords with the beam incident surface of the fiber stub: in contrast, FIG. 4B shows the focusing position of the lens which is deviated from the beam incident surface of the fiber stub. The beam is propagated only inside of the core in the state shown in FIG. 4A. In contrast, a part of the beam leaks to cladding, and then, a cladding mode 41 propagated in the cladding is generated in the state shown in FIG. 4B. As the deviation from the focusing position becomes larger, the rate of the cladding mode 41 becomes higher. According to the present invention, a deviated distance is about 100 μm in order to give an attenuation of 2 dB. In contrast, an attenuation of 5 dB is required in the related art in which no stationary beam attenuation is given, and therefore, a deviated distance needs to be 300 μm.

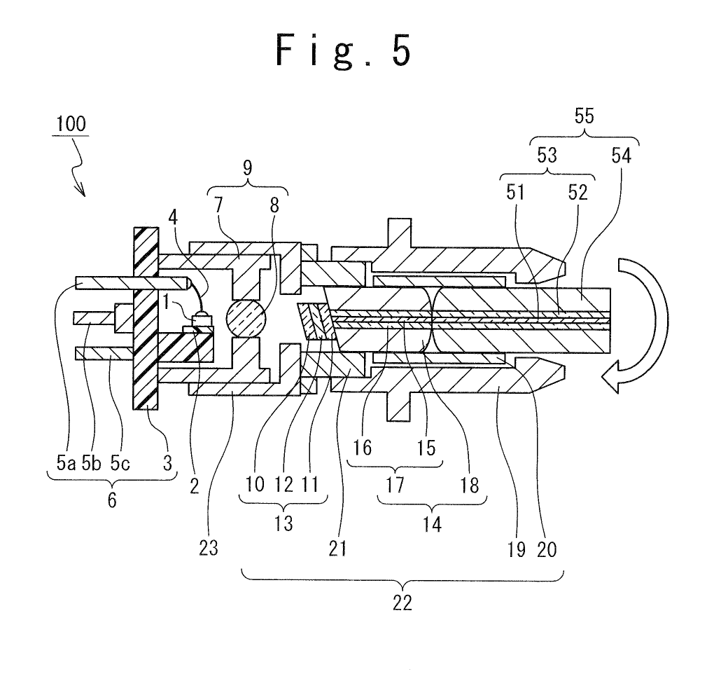

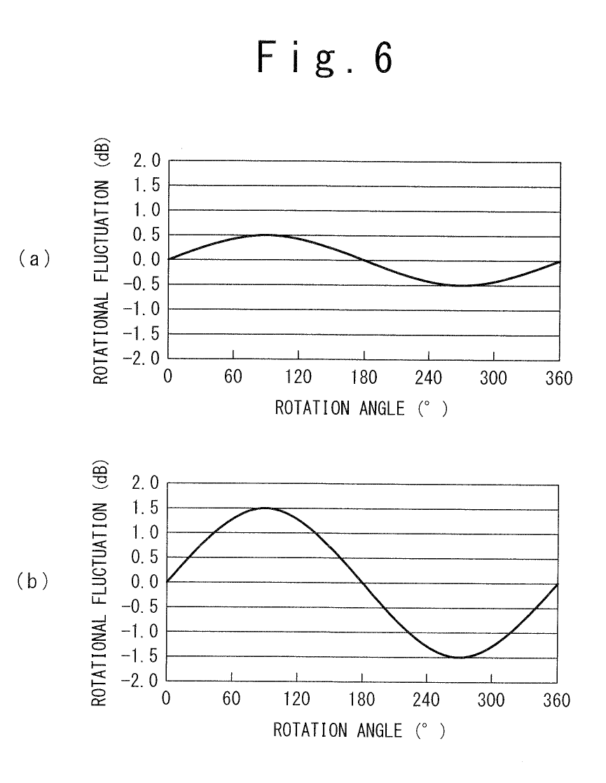

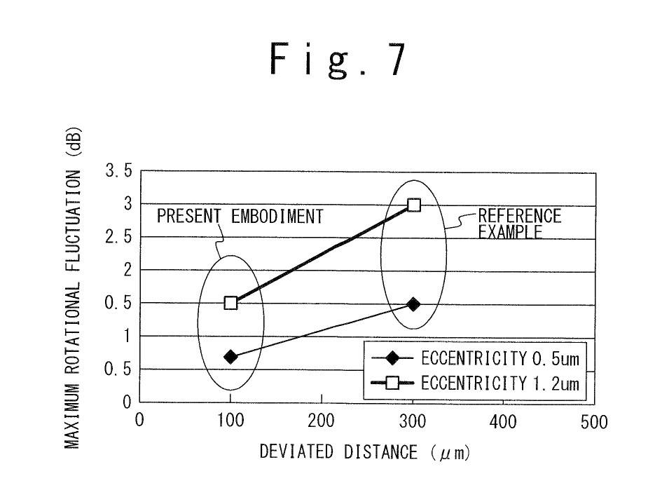

FIG. 5 is a view showing the optical fiber cord 55 connected to the semiconductor laser module 100 in the present embodiment. In this state, FIG. 6 illustrates measurement results of rotational fluctuations of the fiber stub and the optical fiber cord when the optical fiber cord 55 is rotated. The eccentricity of the optical fiber cord 55 is 1.2 μm. FIG. 6(a) illustrates the measurement results according to the present embodiment; and FIG. 6(b) illustrates the measurement results in a related art for comparison. FIG. 7 is a graph illustrating the relationship between a maximum rotational fluctuation and the deviated distance in a case where the eccentricities of the optical fiber cord are 1.2 μm and 0.5 μm in comparison of the present embodiment with a related art. In the case of 1.2 μm, an improvement of 1.5 dB is observed, and further, an improvement of about 0.8 dB is observed even in the case of a small eccentricity of 0.5 μm. According to the present embodiment, since the deviated distance can be reduced, the rate of the cladding mode 41 can be reduced, thus also reducing the fluctuation of the coupling efficiency. Although the eccentricity of the fiber core is exemplified in the present embodiment, it may be replaced with a positional deviation between module members or fiber cores caused by machining tolerance.

Furthermore, since an attenuator is fixed and the optical output adjusting method is directed to only the adjustment of the deviated distance according to the present embodiment, the adjusting process neither is increased nor becomes difficult in comparison with related arts. The fiber stub 14 is not rotated during the optical output adjustment, so that it is to be understood that a return beam can be held to be suppressed.

Moreover, another effect is achieved in the present embodiment. The optical fiber cord connected to the semiconductor laser module 100 is appropriately selected according to the system in which the optical transceiver is incorporated. To the semiconductor laser module 100 is connected, for example, a single mode fiber having a core diameter of 10 μm, a mode conditioning patch cord or a multiple mode fiber having a core diameter of 62.5 μm. The TOSA requires for a small difference in coupling beam ratio of optical outputs according to the type of the optical fiber cord to be connected.

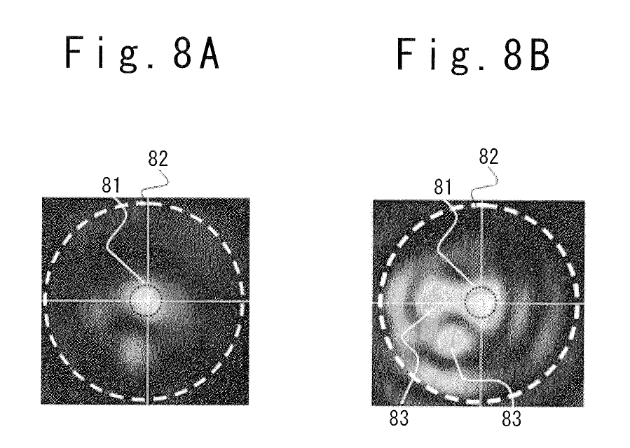

FIGS. 8A and 8B show diagrams for explaining an optical intensity distribution at an output end 27 of the fiber stub 14 in the semiconductor laser module 100. Two circles in each of FIGS. 8A and 8B correspond to a core diameter 81 of a single mode fiber and a core diameter 82 of a multiple mode fiber, respectively. FIG. 8A illustrates a state in which the focusing position of the lens almost accords with the beam incident surface of the fiber stub. In this state, the beam is distributed within the core diameter 81 of the single mode fiber. In contrast, FIG. 8B illustrates a state in which the focusing position of the lens is deviated from the beam incident surface of the fiber stub. In this state, a cladding mode 83 is generated, and therefore, the beam falls out of the core diameter 81 of the single mode fiber, although the beam is distributed within the core diameter 82 of the multiple mode fiber. The cladding mode is not coupled to the single mode fiber, and therefore, the coupling efficiency in the single mode fiber is unfavorably reduced.

As described above, the cladding mode 83 is reduced according to the present embodiment, so that the difference in coupling beam ratio of optical power can be reduced according to the type of the optical fiber cord to be connected. An improvement of about 3 dB is observed in the present embodiment in comparison with the related art.

### Second Embodiment

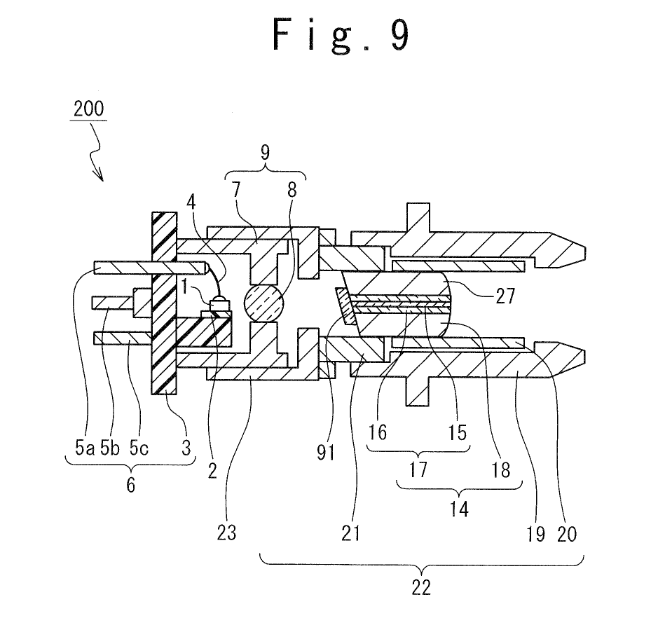

FIG. 9 is a cross-sectional side view showing a semiconductor laser module 200 (i.e., a TOSA) of a receptacle type in a second embodiment according to the present invention. The configuration of the module is basically identical to that in the first embodiment. A polarizer 91 serving as a fixed optical attenuator is stuck to a beam incident surface 24 of a fiber stub 14 in place of the isolator 13 in the first embodiment. The polarizer 91 is fixed to the fiber stub 14 in such a manner as to give an attenuation of 3 dB. Although the polarizer 91 can reduce a return beam from the outside of the module by 3 dB, it cannot exhibit as an excellent suppressing performance as the isolator 13. As a consequence, the semiconductor laser 1 should be desirably of a Fabry-Pérot type which is relatively resistant against the return beam. Effects produced in the present embodiment are the same as those produced in the first embodiment. The attenuation may be appropriately set based on the relationship illustrated in FIG. 3, as required, also in the present embodiment similarly to in the first embodiment.

### Third Embodiment

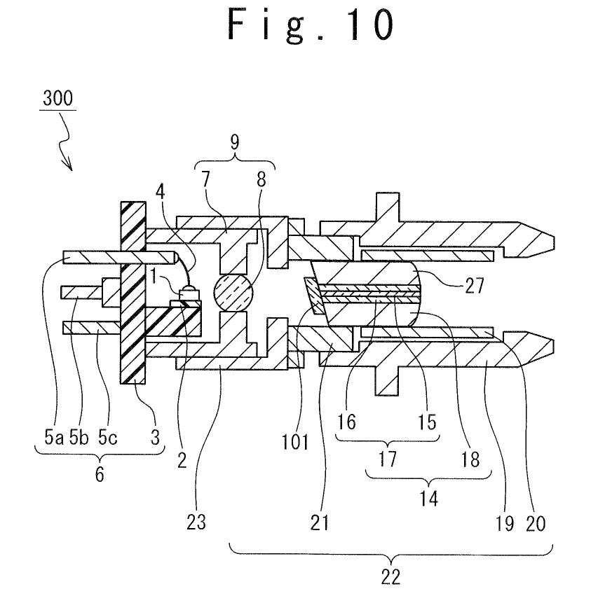

FIG. 10 is a cross-sectional side view showing a semiconductor laser module 300 (i.e., a TOSA) of a receptacle type in a third embodiment according to the present invention. In the configuration of the module, a neutral density (abbreviated as “an ND”) filter 101 serving as a fixed optical attenuator is stuck to a beam incident surface 24 of a fiber stub 14 in place of the polarizer 91 used in the second embodiment. The transmittance of the ND filter 101 is adjusted by coating a glass plate with metal. In the present embodiment, the ND filter 101 having a transmittance of 50% is used, and thus, gives an attenuation of 3 dB. Although the ND filter 101 has a reflectivity of 50%, a return beam to the semiconductor laser 1 cannot be increased even if the ND filter 101 stuck to the beam incident surface 24 reflects the beam 26 emitted from the semiconductor laser 1 in the arrangement in which a beam reflected on the beam incident surface 24 of the fiber stub 14 can be suppressed. Like the polarizer 91, the ND filter 101 can reduce the return beam from the outside of the module by 3 dB, but does not exhibit as an excellent suppressing performance as the isolator 13. As a consequence, the semiconductor laser 1 should be desirably of the Fabry-Pérot type which is relatively resistant against the return beam. Effects produced in the present embodiment are the same as those produced in the first embodiment. A desired attenuation may be properly set by appropriately setting the transmittance of the ND filter 101, as required, in the present embodiment.

### Fourth Embodiment

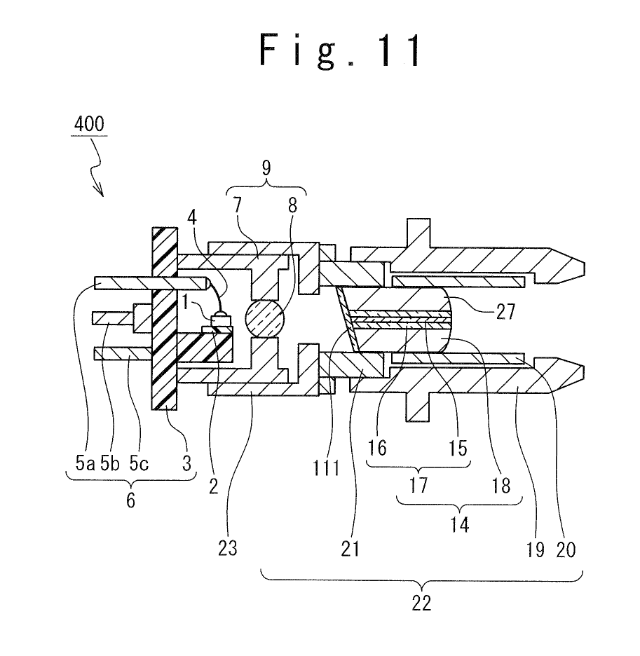

FIG. 11 is a cross-sectional side view showing a semiconductor laser module 400 (i.e., a TOSA) of a receptacle type in a fourth embodiment according to the present invention. In the configuration of the module, a dielectric film 111 serving as a fixed optical attenuator is coated on the beam incident surface 24 of the fiber stub 14, in place of the polarizer 91 used in the second embodiment. The dielectric film 111 having a transmittance of 50% is used, and thus, gives an attenuation of 3 dB. Although the dielectric film 111 has a reflectivity of 50%, a return beam to the semiconductor laser 1 cannot be increased for the same reason as that in the third embodiment. Like the polarizer 91, the dielectric film 111 can reduce the return beam from the outside of the module by 3 dB, but does not exhibit as an excellent suppressing performance as the isolator 13. As a consequence, the semiconductor laser 1 should be desirably of the Fabry-Pérot type which is relatively resistant against the return beam. Effects produced in the present embodiment are the same as those produced in the first embodiment. A desired attenuation may be properly set by appropriately setting the transmittance of the dielectric film 111, as required, in the present embodiment.

### Fifth Embodiment

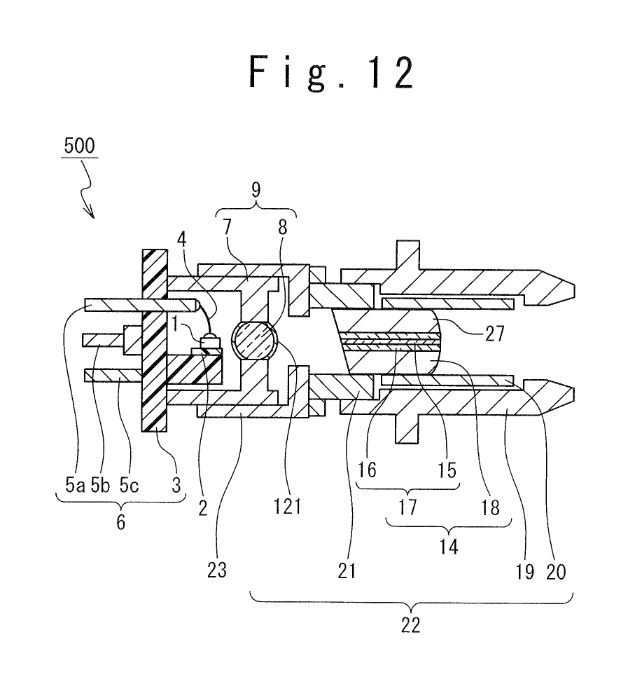

FIG. 12 is a cross-sectional view showing a semiconductor laser module 500 (i.e., a TOSA) of a receptacle type in a fifth embodiment according to the present invention. In the configuration of the module, a lens 8 is coated with a dielectric film 121 as a fixed optical attenuator in place of the polarizer 91. The dielectric film 121 may be replaced with an ND filter film. The dielectric film 121 having a transmittance of 50% is used, and thus, gives an attenuation of 3 dB. Since the lens 8 is formed into a sphere although the lens 8 has a reflectivity of 50%, no return beam to the semiconductor laser 1 can be generated even if the beam 26 emitted from the semiconductor laser 1 is reflected. Like the polarizer 91, the dielectric film 111 can reduce the return beam from the outside of the module by 3 dB, but does not exhibit as an excellent suppressing performance as the isolator 13. As a consequence, the semiconductor laser 1 should be desirably of the Fabry-Pérot type which is relatively resistant against the return beam. Effects produced in the present embodiment are the same as those produced in the first embodiment. A desired attenuation may be properly set by appropriately setting the transmittance of the dielectric film 121, as required, also in the present embodiment similarly to in the fourth embodiment.

As another example of embodiments of the present invention, an optical transceiver module can be exemplified.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A semiconductor laser module comprising:
a semiconductor laser;
a lens;
a fiber stub having a slantwise cut surface to which a emission light emitted from the semiconductor laser and passing through the lens is incident, and the cut surface is arranged in a position deviated from a focus of the lens in a direction of an optical axis of the fiber stub; and
a fixed optical attenuator arranged on a path of an emission light of the semiconductor laser and having an incident surface being oblique to an optical axis of the semiconductor laser.

2. The semiconductor laser module according to claim 1, wherein the fixed optical attenuator is arranged on the slantwise cut surface.

3. The semiconductor laser module according to claim 2, wherein the fixed optical attenuator is an isolator including a polarizer on an incident side thereof to which an emission light emitted from the semiconductor laser is incident.

4. The semiconductor laser module according to claim 3, wherein an angle between a polarization direction of the polarizer and a polarization direction of an emission light emitted from the semiconductor laser is 45°.

5. The semiconductor laser module according to claim 3, wherein the semiconductor laser is a distribution feedback type.

6. The semiconductor laser module according to claim 2, wherein the fixed optical attenuator is a polarizer.

7. The semiconductor laser module according to claim 2, wherein the fixed optical attenuator is a neutral density filter.

8. The semiconductor laser module according to claim 2, wherein the fixed optical attenuator is a dielectric film.

9. The semiconductor laser module according to claim 1, wherein the fixed optical attenuator is a dielectric film formed on the lens.

10. The semiconductor laser module according to claim 1, wherein the fixed optical attenuator is a neutral density filter formed on the lens.

11. The semiconductor laser module according to claim 6, wherein the semiconductor laser is Fabry-Pérot type.
